(19) United States
(12) Patent Application Publication
(10) Pub. No.: US 2014/0351002 A1
(43) Pub. Date: Nov. 27, 2014

(54) CONTENT EFFECTIVENESS VIA ANALYSIS OF THE PROVISIONING THEREOF BY A CONTENT DISTRIBUTION SYSTEM

(71) Applicant: Fippex Operations LLC, Chicago, IL (US)

(72) Inventors: David Pessis, Chicago, IL (US); William Burnett, Chicago, IL (US)

(21) Appl. No.: 13/901,244

(22) Filed: May 23, 2013

(51) Int. Cl. G06Q 30/02

(52) U.S. Cl. CPC G06Q 30/0201
USPC 705/7.29

(57) ABSTRACT

The facilitation of access to content may be enhanced. The content may be received from a content provider. The content may be made available for access by a plurality of content consumers. Data related to access to the content by at least one of the plurality of content consumers may be obtained. The obtained data may be analyzed. One or more recommendations corresponding to the content may be formulated. The one or more recommendations may be provided to the content provider.

### BACKGROUND

Content platforms may generally include computer based systems that facilitate the distribution or communication of information or content, such as advertisements, coupons, entertainment, descriptions, brochures, specifications, designs, proposals, tutorials, schedules, etc., from content providers to content consumers using various electronic media, such as audio, text, video, document(s), etc.. A content platform may, for instance, be used as a marketing or advertising platform to facilitate the transmission or distribution of advertisements for products or services from, for example, a third-party content provider. A content platform may, as another example, be used as a document, or other media, delivery or sharing platform to facilitate the transmission or distribution of documents, or other media, from content providers to content consumers. For example, an investor communications platform may facilitate the transmission of compliance information, such as prospectuses, supplements, shareholder reports, etc., from content providers (e.g., brokerage firms, mutual fund companies) to investors.

### BRIEF DESCRIPTION OF THE DRAWINGS

The examples of the invention described below can be better understood with reference to the following figures. The components in the figures are not necessarily to scale, emphasis instead being placed upon illustrating the principles of the invention. In the figures, like reference numerals designate corresponding parts throughout the different views.

FIG. 1 depicts a block diagram of an example of a system for enhancing the facilitation of access to content.

FIG. 2 depicts a block diagram of an example of a content platform of the system shown in FIG. 1.

FIG. 3 depicts a flow chart showing operation of the system in FIG. 1.

FIG. 4 depicts an exemplary computer system for use with the system of FIG. 1.

### DETAILED DESCRIPTION OF THE DRAWINGS AND PRESENTLY PREFERRED EMBODIMENTS

The disclosed embodiments generally relate to enhancing the facilitation of access to content by a plurality of content consumers, the content being provided by a content provider. Unlike known content distribution platforms, which may facilitate the distribution or communication of information or content from content providers to content consumers, the disclosed embodiments provide a content distribution platform that not only makes content available for access by content consumers, but also formulates content-related recommendations based on, for example, the access to the content by one or more content consumers.

The content-related recommendations may be directed to attaining the content provider's goal for, and/or purpose in, creating/providing the content in the first place. For example, the content provider may seek to enhance or otherwise improve the effectiveness or usage of the content, and/or the delivery thereof. The content provider may, alternatively or additionally, seek to encourage or facilitate a desired action (e.g., the purchase of subject products or services, the purchase of additional content, a choice, or combinations thereof) by one or more content consumers following access to and consumption of the content. The content provider may, alternatively or additionally, seek to improve or facilitate the retention and/or comprehension (e.g., the educational value) of the content.

The content-related recommendations may be directed to (i) improve or enhance the effectiveness or usage of the content by, for example, improving the visibility of specific content, identifying underutilized content, and/or minimizing early abandonment of the content by the one or more content consumers, (ii) encouraging or facilitating the desired action by, for example, interacting with one or more content consumers and/or marketing specific products and/or services to one or more content consumers, (iii) improving the retention or comprehension of the content by, for example, re-arranging the content and/or portions thereof, and/or reducing or simplifying the content and/or portions thereof, or (iv) combinations thereof. In turn, the consumption and/or effectiveness of the content may be improved, subsequent access to the content by the one or more content consumers may be altered, influenced, or improved, one or more subsequent actions performed by the one or more content consumers may be facilitated or influenced, the retention and/or comprehension of the content by the one or more content consumers may be improved, or combinations thereof, in satisfaction of the content provider's goal. More effective content may then, for example with respect to advertising or marketing related content, result in improved sales of the subject products or services.

To clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions herebefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

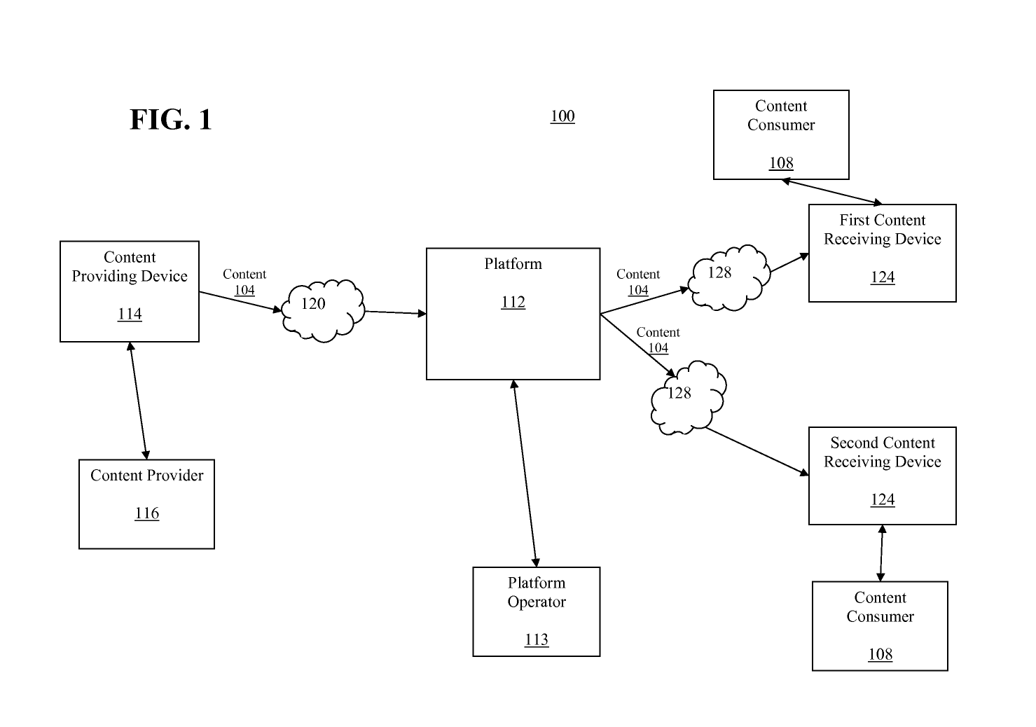

FIG. 1 shows a block diagram of one embodiment of a system 100 for enhancing the facilitation of access to content 104 by a plurality of content consumers 108. The system 100 generally includes a content platform 112 created and/or operated by, or otherwise associated with, a platform host, operator, or intermediary 113 (e.g., Fippex.com). The platform 112 is coupled with or connected to a content providing device 114 associated with the content provider 116 via a communication network 120. The platform 112 is also coupled with or connected to a plurality of content receiving devices 124 associated with the plurality of content consumers 108, respectively, via a communication network 128. As used herein, the phrases “in communication” and “couple” include a direct connection or an indirect connection through one or more intermediate components. Such intermediate components may include hardware and/or software based components.

In other embodiments, the system 100 may include additional, different, or fewer components. For example, the system 100 may include additional content providers 116 and/or content providing devices 114 (associated with the content provider 116 or additional content providers 116) and/or only one content consumer 108. As another example, the system 100 may include additional platforms 112 and/or communication networks 120, 128.

The platform 112 may comprise a cloud-based content storage, management, distribution, reporting, and recommendation platform. In other embodiments, the platform 112 need not be cloud-based (i.e., it may be desktop-based) and/or it need not be used for all of the above-listed purposes (e.g., storage, reporting, etc.). As noted above, the platform 112 is created and/or operated by the platform operator or intermediary 113. The platform operator 113 facilitates the storage, management, distribution, reporting, or combinations thereof, and/or the provision of recommendations pertaining to the content.

The content 104 is provided to the platform 112 by the content provider 116. In some embodiments, the content 104 may be provided by a plurality of different content providers 116. The content 104 includes any type of content that may be created and stored in an electronic format. The content 104 may include or be text (e.g., documents), images, video content (e.g., one or more videos or video clips), audio content, other content, or combinations thereof, stored in any number of different formats (e.g., .doc, .pdf, .txt, .rtf, .xml, HTML, JPEG, Bitmap, Tiff, SVG, AVI, MOV, MPG, WMV, MP3, WAV, etc.) The content 104 may include or be news (e.g., announcements), notifications or alerts, event information, maps, weblinks, surveys, contact information, forms, presentations, brochures, specifications, designs, tutorials, proposals, renderings, financials, contracts, order and/or inventory information, other files or information, or combinations thereof, for, about, or associated with the content provider 116, one or more of the content consumers 108, one or more products, services, marketing campaigns, projects for or associated with the content provider 116 and/or one or more of the content consumers 108, or combinations thereof. The content 104 may be tailored to one or more specific content consumers 108 or one or more groups of content consumers 108.

The content provider 116 may be a retailer or merchant, manufacturer, distributor, service provider, organization (e.g., corporation, government entity, other business entity), or combinations thereof. In one embodiment, the content provider 116 is a financial institution (e.g., bank, brokerage firm, insurance company). As noted above, the content provider 116 is associated with the content providing device 114. The content provider 116 may provide the content 104 to the platform 112 via or using the content providing device 114. The content providing device 114 may be a desktop computer, a workstation, a mobile device (e.g., a smartphone, a personal digital assistant), a mobile content platform (e.g., notebook computer, tablet computer), and/or any other known or later developed device associated with the content provider 116. In other embodiments, however, the content provider 116 need not be associated with the content providing device 114 (i.e., the content provider 116 may provide content to the platform 112 without using the content providing device 114).

The platform 112 provides the content 104 to the plurality of content consumers 108. The plurality of content consumers 108 may include or be customers of the content provider 116 (e.g., the content consumers 108 subscribe to or pay for the content provided by the content provider 116), potential customers of the content provider 116, other end users of the content 104 (e.g., a user who registers him/herself with the platform 112), employees, contractors, or persons affiliated with the content provider 116, other persons or users, or combinations thereof. As noted above, the plurality of content consumers 108 are associated with the plurality of content receiving devices 124, respectively. The platform 112 may provide the content 104 to the content consumers 108 using or via the content receiving devices 124. The number of content consumers 108 may or may not equal the number of content receiving devices 124. For example, two or more content consumers 108 may be associated with the same content receiving device 124. Each content receiving device 124 is configured to receive the content 104 from the platform 112, via or using the network 128, and provide (e.g., display, present, output) the content 104 to the consumer(s) 108 associated therewith. The content receiving devices 124 may include one or more desktop computers, one or more workstations, one or more mobile devices (e.g., smartphones, personal digital assistants), one or more mobile content platforms (e.g., notebook computers, tablet computers), and/or any other known or later developed devices, or combinations thereof, associated with the content consumers 108.

The networks 120, 128 may be wireless networks, wired networks, or combinations of a wired and wireless network, such as an 802.11x compliant network. The networks 120, 128 may include publicly accessible networks, such as the Internet, private networks, or combinations thereof. In one embodiment, the network 120 is the same as the network 128 (and vice-versa). The type and configuration of the communication networks 120, 128 are implementation dependent, and any type of communication network that facilitates the described communications between the platform 112 and the content providing device 114 and the platform 112 and the plurality of content receiving devices 124, available now or later developed, may be used. The platform 112 may communicate with the content providing device 114 and the content receiving devices 124 using native or modified communications functionality of the device 114 and/or the devices 124, such as, for example, using the short message server (“SMS”) or multimedia message server (“MMS”) text message protocol, the hypertext transport protocol (“HTTP”) via a web browser application provided by the device 114 and/or the devices 124, the simple mail transfer protocol (“SMTP”), or other email communications protocol, via an email application provided by the device 114 and/or the devices 124, via a proprietary application (“app”) specifically installed on the device 114 and/or the devices 124, which may use a proprietary or non-proprietary protocol, to implement the disclosed functionality, via the telephony functions of the device 114 and/or the devices 124, such as via touch-tone or interactive voice response mechanisms, or combinations thereof.

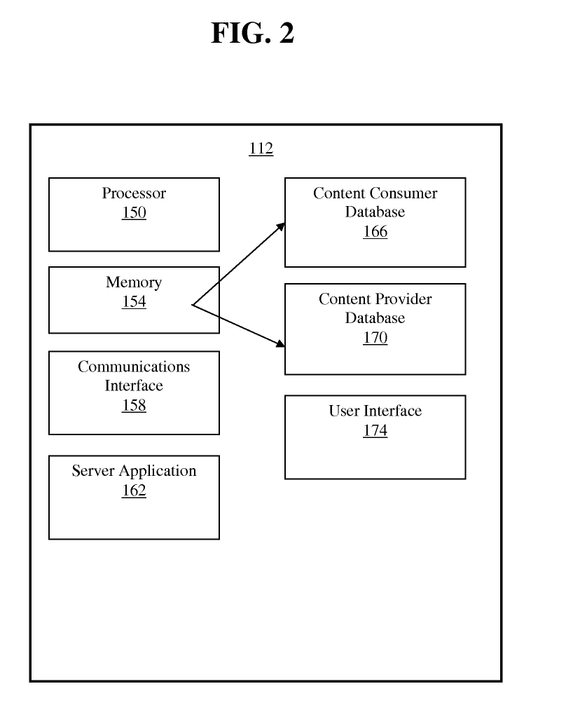

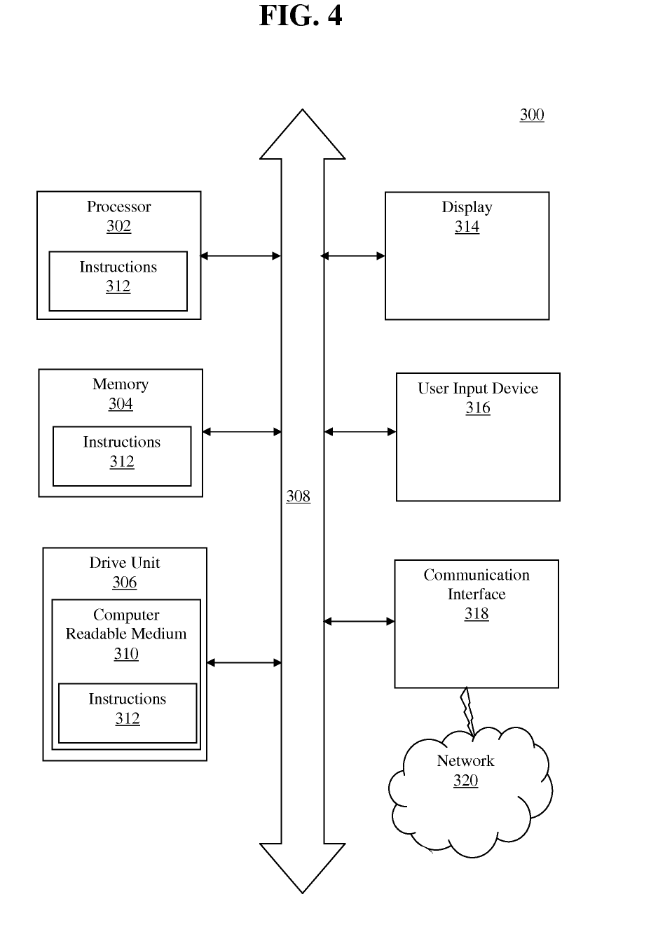

Further details regarding the platform 112 are now described in connection with FIG. 2. As shown in FIG. 2, the platform 112 includes a processor 150, a memory 154, a communications interface 158, and a server application 162. In other embodiments, the platform 112 may include additional, different, or fewer components. For example, the platform 112 may include additional processors 150, memories 154, and/or additional server applications 162 or other server applications (e.g., for performing one or more of the specific tasks described herein). In one other embodiment, the platform 112 may be implemented as computer program logic or computer readable program code stored in the memory and/or storage of a computer, such as the computer 300 described below with respect to FIG. 4, and executable by one or more processors thereof to implement the disclosed functionality.

The processor 150 may be a general processor, a digital signal processor, ASIC, field programmable gate array, graphics processing unit, analog circuit, digital circuit, any other known or later developed processor, or combinations thereof. The processor 150 operates pursuant to instructions in the memory 154. The memory 154 may be a volatile memory or a non-volatile memory. The memory 154 may include one or more of a read only memory (ROM), random access memory (RAM), a flash memory, an electronic erasable program read only memory (EEPROM), or other type of memory. The memory 154 may include an optical, magnetic (hard drive), or any other form of data storage device.

The communications interface 158 is provided to enable or facilitate electronic communication between the platform 112 and the content providing device 114 via the network 120 and/or between the platform 112 and the content receiving devices 124 via the network 128. The communications interface 158 may include two or more communications interfaces, such as a communications interface devoted to sending and/or receiving signals, datagrams, data, packets, or information to/from the content providing device 114 and a communications interface devoted to sending and/or receiving signals, datagrams, data, packets, or information to/from the content receiving devices 124.

The server application 162 may be stored on the memory 154 operated by the platform 112 and loaded into the memory 154 of the platform 112 to be executed by the processor 150. The server application 162 may be written in a suitable computer programming language such as C, although other programming languages (e.g., C++, Java, etc.) are also suitable.

The system 100 also includes a content consumer database 166 stored on or in the memory 154 of the platform 112. The content consumer database 166 may store or maintain a profile, preferences, settings, and/or identifiers or other indicators, such as network identifiers (e.g., IP addresses), telephone numbers, email addresses, etc., of or for the plurality of content consumers 108 and/or the plurality of content receiving devices 124 associated therewith. The content consumer database 166 may also store or maintain authorizations or permissions provided to the platform 112 by one or more of the plurality of content consumers 108. For example, each of the content consumers 108 may provide a permission matrix to the platform 112. One or more content consumers 108 may specify, via the permissions or authorizations, which content they wish to access. This may, for example, include content from certain content providers or only certain types of content (e.g., only news).

The system 100 also includes a content provider database 170 stored on or in the memory 154 of the platform 112. The content provider database 170 stores or maintains content 104 provided to or received or obtained by the platform 112. The content 104 may be arranged, organized, or structured in the database 170 in any number of ways. The content 104 may be arranged (e.g., categorized) based on or using one or more virtual rooms (e.g., one virtual room for each content consumer 108), folders, tabs, screens, some other layout, or combinations thereof. Some of the content 104 may be associated with (e.g., be related to) other content 104. For example, some of the content 104 may be arranged in a hierarchical manner. The content 104 may be arranged based on or as a function of the importance or usefulness of the content 104, a standard or default configuration (e.g., template), one or more intended content consumers 108, one or more groups of intended content consumers 108, or combinations thereof. For example, the content 104 may be organized one way (e.g., into 3 folders) for one content consumer 108 and another way (e.g., into 2 folders) for another content consumer 108. When the content 104 is organized based on or for the one or more intended consumers 108, the content 104 may be organized based on identifiers for the intended content consumers 108 and/or the preferences or profile(s) of the intended content consumers 108. The content 104 may be organized or structured by the content provider 116 and/or by the platform 112 (e.g., automatically).

The content provider database 170 may also store or maintain a profile, preferences, settings, and/or identifiers or other indicators, such as network identifiers (e.g., IP addresses), telephone numbers, email addresses, etc., of or for the content provider 116 and/or the content providing device 114 associated therewith. The content provider database 170 may also store or maintain authorizations or permissions, provided to the platform 112 by the content provider 116, for the content 104. For example, the content provider 116 may provide a permission matrix to the platform 112. The content provider 116 may specify, via the permissions or authorizations, which content consumers 108 may access the content 104, or portions thereof, what content consumers 108 are able to do with accessed content (e.g., at folder level, at document level, etc.), or when the content 104 may be accessed or is to be made available for access. As an example, the content provider 116 may specify that one, some, or all content consumers 108 may access the content. As another example, the content provider 116 may specify that content consumers 108 may or may not view, download, print, edit, or combinations thereof, the accessed content 104. The content provider database 170 may also store or maintain security settings or measures specified by the content provider 116. For example, the content provider 116 may specify that watermarks are to be applied to the content 104 for security purposes.

While the content consumer database 166 and the content provider database 170 are depicted separately, it will be appreciated that they may be implemented in a different manner, such as via a single database having one or more tables or on single or multiple devices or memories. For example, in other embodiments, each content consumer 108 may have a corresponding content consumer database 166 stored on the platform 112. As another example, the content consumer database 166 and the content provider database 170 may be merged into one database. In the embodiments in which two or more content providers 108 utilize the platform 112, the content provider database 170 may be utilized for all of the content providers 108 or one or more separate content provider databases 170 may be utilized for these additional content providers 108.

The platform 112 also includes a user interface 174 that allows the content provider 116 to modify, remove, or add, via the device 114, the content 104 stored in the content provider database 170. The user interface 174 also allows the content consumers 108 to access, via the devices 124, any content 104 that has been made available to them. The user interface 174 further allows the content consumers 108 and/or the content provider 116 to modify, via the devices 114 and/or 124, any of the previously described data or information (e.g., permissions, preferences) stored in the content consumer database 166 and/or the content provider database 170, add similar information thereto, or remove similar information therefrom.

In some embodiments, the platform 112 may provide the same user interface 174 for each of the different content consumers 108. In other embodiments, though, the platform 112 may provide different user interfaces 174 for one or more different content consumers 108. Different user interfaces 174 may be arranged or organized differently, such as, for example, with different layouts, different virtual rooms, different folders, and/or different tabs. The arrangement of the different user interfaces 174 may be based on the respective content consumer(s) 108 (e.g., preferences, identity, etc., of the respective content consumer(s) 108), a standard or default configuration (e.g., a template), the content provider 116 (e.g., preferences, identity, etc., of the content provider 116), or combinations thereof. For example, the platform 112 may provide, for a first content consumer 108, a first user interface 174 that is organized or arranged one way, but may provide, for a second content consumer 108, a second user interface 174 that is organized or arranged a second, different, way. In the embodiments in which there are two or more content providers 116, the platform 112 may provide the same user interface 174 for each of the different content providers 116 or provide different user interfaces 174 for one or more different content providers 116 in a similar manner.

With reference again to FIG. 1, the platform 112 is configured to make the content 104 stored in the database 170 available for access by the plurality of content consumers 108. The platform 112 makes the content 104 available for access by providing (e.g., sharing, publishing, uploading) the content 104 via or using the user interface(s) 174 for the content consumers 108. In other embodiments, the platform 112 may make the content 104 available for access by providing the content 104 via or using a different forum (e.g., a public website, social media). In any event, when the content 104 is arranged or organized as described above, the platform 112 makes the content 104 available for access in this way. When the content 104 is arranged or organized differently for different content consumers 108, the platform 112 may make the content 104 available for access in a way that is consistent with these different arrangements. The platform 112 may, in some embodiments, also invite access to the content 104 or notify one or more content consumers 108 that the content 104 is available for access, such as, for example, by transmitting an email or text message to one or more content consumers 108. As an example, the platform 112 may send an email or text message that informs each of the one or more content consumers 108 that he/she has been invited to access the content 104 via the user interface(s) 174 of the platform 112.

The platform 112 may make the content 104 available for access based on the permissions or authorizations, settings, and/or other information or data also stored in the content provider database 170. For example, the platform 112 provide the content 104 to only some of the content consumers 108, via their associated user interface(s) 174, based on permissions, indicating that only some of the content consumers 108 are to have access to the content 104, stored in the content provider database 170. The platform 112 may, alternatively or additionally, make the content 104 available for access based on the permissions or authorizations, settings, and/or other information or data stored in the content consumer database 166. For example, the platform 112 may make the content 104 available for access by only two of the content consumers 108 based on permissions, indicating these two content consumers 108, and no other content consumers 108, wish to have access to the content 104. The platform 112 may be configured to make the content 104 available for access in response to a request received from the content provider 116 and/or the content providing device 114 associated therewith and/or a request received from one or more content consumers 108 and/or the content receiving devices 124 associated therewith (i.e., a “pull”), and/or make the content 104 automatically available for access, such as upon receiving and/or storing the content 104, on a period schedule, or in response to an event or other signal (i.e., a “push”).

The content 104 may, in turn, be provided (e.g., presented, displayed, output) to one or more content consumers 108 via one or more content receiving devices 124. For example, the content 104 may be provided to a content consumer 108 in the user interface 174 displayed on the content receiving device 124 associated with that content consumer 108. The provided content 104 may then be accessed (e.g., reviewed, utilized, downloaded) by one or more of the content consumers 108.

When the platform 112 determines that the content 104 has been accessed by one or more of the content consumers 108, the platform 112 is configured to obtain (e.g., collect, gather) data related to or indicative of access to the content 104 by the one or more of the content consumers 108. The platform 112 may obtain the data for some or each of the one or more content consumers 108 that access the content 104 (e.g., using the user interface(s) 174). The data may be collected or gathered directly by the platform 112, indirectly obtained by the platform 112 (e.g., through or using the content provider 116, or a combination thereof.

The data may be related to or indicative of the extent, nature, attributes, or characteristics of the access by the one or more content consumers 108. The data may, for example, be related to which content 104 was accessed (e.g., which aspects or portions of the content 104 were accessed vs. which aspects of the content 104 were not accessed), how long the content 104 was accessed (e.g., how long did the one or more content consumers 108 loiter), when the content 104 was accessed (e.g., day, time of day), how much of the content 104 was accessed (e.g., how far into the content 104 did the one or more content consumers 108 get), when the content consumer(s) 108 logged-out (i.e., stopped accessing the content 104), modifications to the content 104 (e.g., edits), the number of replies (e.g., email replies) by the one or more content consumers 108, which aspects or portions of the content 104 were replied to vs. which aspects of the content 104 were not replied to by the one or more content consumers 108, how quickly the one or more content consumers 108 took to respond to the content 104 and/or portions thereof, the number of content receiving devices 124 and/or other devices were used to access the content 104 (e.g., people who access content 104 from multiple devices may be more interested and/or likely to convert), or combinations thereof. Other data that relates to the extent, nature, attributes, or characteristics of the access may be obtained instead or as well.

The data may, alternatively or additionally, be related to or indicative of activities (e.g., gestures, commands, input, etc.) of the one or more content consumers 108 while accessing the content 104. The data may, for example, be a clickstream for each of the one or more content consumers 108 and/or conversions (e.g., downloads, registrations) for each of the one or more content consumers 108 while the one or more content consumers 108 are accessing the content 104. The data may, as another example, be related to translational and/or rotational movement of a portion or a body part (e.g., eye(s), head, shoulder, finger, etc.) of the one or more content consumers 108 while accessing the content 104. For example, the data may indicate that one content consumer 108 diverted attention away from specific content 104 while accessing it. Further yet, the data may be related to input, such as, for example, touching, pressure, text commands, verbal commands, or combinations thereof, by the one or more content consumers 108 of, applied to, or input into the associated user interfaces 174.

The data may, additionally or alternatively, be related to characteristics (e.g., measurements) of the one or more content consumers 108 before, while, and/or after accessing the content 104. For example, the data may be related to or indicative of the respiration rate, heart rate, body temperature, electroencephalography (EEG), pupil dilation, eye tracking (i.e., what are the eyes focusing on), other characteristics, or combinations thereof, of the one or more content consumers 108 before, after, and/or while accessing the content 104.

The platform 112 is configured to analyze the obtained (e.g., collected, gathered) data related to or indicative of access to the content 104 by the one or more content consumers 108. The analysis may be any type of statistical analysis. The analysis may be performed for or with respect to an individual content consumer 108, two or more content consumers 108, or all of the content consumers 108 that the platform 112 determines has/have accessed the content 104. In the embodiments in which more than one content provider 116 exists, the analysis may be performed for or with respect to one or more specific content providers 116 or all of the content providers 116.

The analysis generally aims to track and/or predict (e.g., model) the interest, comprehensibility, and/or effectiveness of the content 104, gauge, identify, or determine the interest and/or truthfulness of the one or more content consumers 108 . The analysis may thus include determining, identifying, or detecting the behavioral or content access pattern(s) of or for the one or more content consumers 108. For example, the platform 112 may determine or identify the order in which content 104 and/or portions thereof is typically accessed (e.g., what content 104 is typically accessed before other content? what content 104 is typically accessed after other content?), content 104 and/or portions thereof that correspond to a pre-defined high and/or low number of exits or abandonments, content 104 and/or portions thereof that correspond to high and/or lower loiter times, content 104 and/or portions thereof that correspond to high and/or low body temperatures, content 104 and/or portions thereof that eyes of the content consumers 108 tend to focus on, or combinations thereof. As another example, the platform 112 may determine or identify the most active content consumer 108, one or more active content consumers 108, the least active content consumer 108, one or more non-active content consumers 108, or combinations thereof. In a further example, the platform 112 may determine or identify the most popular content (e.g., most accessed, most shared), popular content (e.g., content accessed a number of times in excess of a pre-defined threshold), a most popular set or collection of content, one or more popular sets or collections of content, a percentage of content consumers given access to content who actually access (e.g., utilize, view, download) the content, a percentage of situations in which content consumers 108 have access to, but do not actually access, content 104 and/or portions thereof, or combinations thereof. Other behavior or content usage patterns may be determined instead or as well.

In one embodiment, the analysis may include correlating the obtained data with pipeline or transaction data (e.g., for transactions consummated on or using the platform 112 and/or corresponding to one or more products or services associated with the content 104 and/or the content provider 116) obtained (directly or indirectly) by the platform 112. The platform 112 may, in turn, identify correlations between sales or transactions and behavioral patterns and/or content usage and/or effectiveness. For example, the platform 112 may identify a correlation between access by content consumers 108 to a specific portion of the content 104 and sales. As another example, the platform 112 may determine that a correlation exists between the number of times content consumers 108 access the content 104 and/or portions thereof and sales. Any other number of correlations may be determined or identified by the platform 112.

The platform 112 is configured to formulate or generate one or more recommendations corresponding to the content 104 based on the analysis of the obtained data. The one or more recommendations are generally configured to improve or enhance the effectiveness or usage of the content 104. More specifically, the one or more recommendations are configured to alter, influence, or improve subsequent access to the content 104 by the one or more content consumers 108 and/or alter or influence one or more subsequent actions performed by the one or more content consumers 108 based on subsequent access. For example, the one or more recommendations may be configured to improve visibility of the content 104, identify underperforming or underutilized content 104, or minimize early abandonment by the one or more content consumers 108. As another example, the one or more recommendations may be configured to influence a decision by a content consumer 108 to purchase a product and/or service (e.g., a product and/or service that is the subject of the content 104) after accessing the content 104.

The one or more recommendations may be or include one or more recommendations to generally modify the content (e.g., the content is not being utilized effectively and should be modified) and/or one or more specifically recommended modifications to the content (e.g., it is recommended that the content be modified by doing X, Y, and Z). The one or more recommendations may, for example, be or include one or more recommended or suggested edits, deletions, additions, or combinations thereof, to the content 104. For example, the platform 112 may recommend that portions of the content 104, which are typically not accessed or are highly correlated with abandonments, be deleted. As another example, the platform 112 may recommend that content 104, which is highly correlated with sales, be added for one or more specific content consumers 108. As yet another example, the platform 112 may recommend that the signal-to-noise ratio, e.g., the ratio of relevant to irrelevant content, be improved for the content 104 and/or portions thereof. For example, the platform 112 may recommend reducing the use of industry jargon, an overall reduction in extraneous verbiage, etc. The one or more recommendations may, as another example, be or include re-arranging the content 104 and/or portions thereof, and/or highlighting or emphasizing certain portions of the content 104. For example, the platform 112 may recommend highlighting a portion of the content 104 determined to be highly correlated to consummated transactions.

The one or more recommendations may be or include one or more generally recommended actions (e.g., consider interacting with the content consumers 108 more frequently) and/or one or more specifically recommended actions to be performed by the content provider 116. In other embodiments, the one or more recommended actions may be automatically performed by the platform 112 and/or be performed by another organization or entity (e.g., one associated with the content provider 116 and/or the content 104). The actions may be or include interacting with one or more of the content consumers 108 based on access activity by the one or more content consumers 108 using or via the platform 112. The actions may be or include emailing, messaging, calling, or otherwise contacting one or more content consumers 108 at certain times before, during, and/or after the content 104 is accessed. The one or more recommendations may further include advice or guidance pertaining to those actions such as, for example, when to interact with the one or more content consumers 108 (e.g., which time(s) is/are best), how to interact with the one or more content consumers 108 (e.g., interaction is suggested via a specific content receiving device 124, interaction is suggested using another means of communication), what to say when interacting with the one or more content consumers 108 (e.g., a sample script may be provided).

The platform 112 may, in some embodiments, provide a score associated with the one or more recommendations. The score may be indicative of the likelihood of converting one or more of the content consumers 108 (e.g., based on previous and/or current access and/or other data), the importance of one or more of the content consumers 108 (e.g., some content consumers 108 may pay a premium), the degree to which detailed recommendations should be provided (e.g., some content providers may wish to receive more detailed recommendations), or the like.

Based on the one or more recommendations, and, in some cases, on the associated score, guidance may be provided to the content consumers 108, questions from the content consumers 108 may be answered, one or more products and/or services may be marketed to the content consumers 108, other interactions may occur, or combinations thereof. For example, the platform 112 may recommend that the content provider 116 market specific products and/or services to content consumers 108 after consumers 108 access specific portions of the content 104, such as, for example, portions of the content 104 the access to which is determined to highly correlate with consummated transactions. As another example, the platform 112 may recommend that the content provider 116 contact the content consumers 108 to answer questions after the consumers 108 access specific portions of the content 104, such as, for example, portions of the content 104 the access to which is determined to highly correlate with early abandonments.

The platform 112 is configured to provide the one or more formulated recommendations to the content provider 116. The platform 112 may provide the one or more recommendations to the content provider 116 via the user interface 174 (e.g., provided on the content device 114) or in some other way (e.g., via email) using the content device 114. The content provider 116 may, in turn, implement one or more of the recommendations. For example, the content provider 116 may modify the content 104 provided to the platform 112 based on the recommendations. Alternatively or additionally, the platform 112 may automatically modify the content 104 based on the one or more recommendations. For example, the platform 112 may automatically edit, delete, add to, or re-arrange the content 104 based on the generated recommendations.

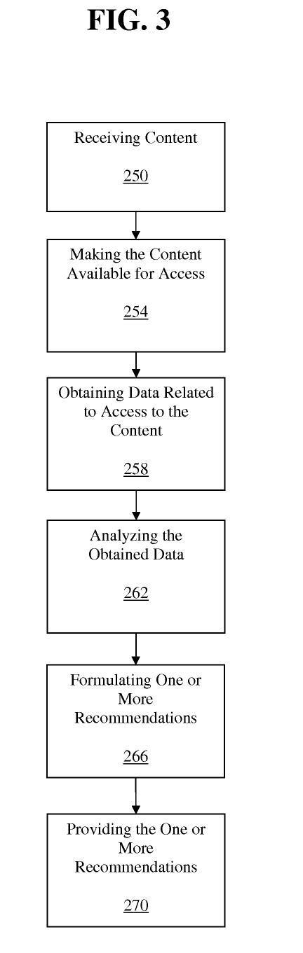

Referring to FIG. 3, there is shown a flow chart depicting the operation of the system 100 for enhancing the facilitation of access to content according to one embodiment. In one embodiment, the system includes the content distribution platform 112, implemented as a computer having a processor and a memory coupled thereto. In other embodiments, a different system may be used and/or additional, different, or fewer acts may be included in the operation. For example, the receiving, making, obtaining, analyzing, formulating, and providing acts may be performed any number of times, such as, for example, in connection with any number of content consumers 108.

The operation or method includes receiving the content 104 (act 250). The content is provided by the content provider 116. The operation or method also includes making the content 104 available for access by the plurality of content consumers 108 (act 254). In one embodiment, making the content 104 available for access includes sharing the content 104 with the plurality of content consumers 108 and notifying the plurality of content consumers 108 that the content 104 has been shared. In another embodiment, making the content 104 available for access includes providing the content 104 to the plurality of content consumers 108, the content 104 categorized into one or more rooms. In another embodiment, making the content 104 available includes providing the content 104 to the plurality of content consumers 108 based on one or more permissions provided by the content provider 116.

The operation or method also includes obtaining data related to access to the content 104 by at least one of the plurality of content consumers 108 (act 258). In one embodiment, obtaining the data includes collecting data related to an extent, nature, characteristic, or combinations thereof, of the access to the content. The operation or method also includes analyzing the obtained data (act 262). The one or more recommendations correspond to the content 104. In one embodiment, analyzing the obtained data includes identifying one or more content access patterns for the at least one content consumer 108. In another embodiment, analyzing the obtained data includes correlating the obtained data with transaction data indicative of previously consummated transactions.

The operation or method also includes formulating one or more recommendations based on the analysis (act 266). In one embodiment, formulating one or more recommendations includes formulating one or more recommended modifications to the content 104. In another embodiment, formulating one or more recommendations includes formulating one or more recommended actions to be performed by the content provider 116 based on the content 104. The operation or method further includes providing the one or more recommendations to the content provider 116 (act 270). In one embodiment, the operation of the system 100 may further include automatically modifying the content 104 based on the one or more recommendations.

Referring to FIG. 4, an illustrative embodiment of a general computer system 300 is shown. The computer system 300 can include a set of instructions that can be executed to cause the computer system 300 to perform any one or more of the methods or computer based functions disclosed herein. The computer system 300 may operate as a standalone device or may be connected, e.g., using a network, to other computer systems or peripheral devices. Any of the components discussed above may be a computer system 300 or a component in the computer system 300.

In a networked deployment, the computer system 300 may operate in the capacity of a server or as a client user computer in a client-server user network environment, or as a peer computer system in a peer-to-peer (or distributed) network environment. The computer system 300 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine In a particular embodiment, the computer system 300 can be implemented using electronic devices that provide voice, video or data communication. Further, while a single computer system 300 is illustrated, the term “system” shall also be taken to include any collection of systems or sub-systems that individually or jointly execute a set, or multiple sets, of instructions to perform one or more computer functions.

As illustrated in FIG. 4, the computer system 300 may include a processor 302, e.g., a central processing unit (CPU), a graphics processing unit (GPU), or both. The processor 302 may be a component in a variety of systems. For example, the processor 302 may be part of a standard personal computer or a workstation. The processor 302 may be one or more general processors, digital signal processors, application specific integrated circuits, field programmable gate arrays, servers, networks, digital circuits, analog circuits, combinations thereof, or other now known or later developed devices for analyzing and processing data. The processor 302 may implement a software program, such as code generated manually (i.e., programmed).

The computer system 300 may include a memory 304 that can communicate via a bus 308. The memory 304 may be a main memory, a static memory, or a dynamic memory. The memory 304 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 304 includes a cache or random access memory for the processor 302. In alternative embodiments, the memory 304 is separate from the processor 302, such as a cache memory of a processor, the system memory, or other memory. The memory 304 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 304 is operable to store instructions executable by the processor 302. The functions, acts or tasks illustrated in the figures or described herein may be performed by the programmed processor 302 executing the instructions stored in the memory 304. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 300 may further include a display unit 314, such as a liquid crystal display (LCD), an organic light emitting diode (OLED), a flat panel display, a solid state display, a cathode ray tube (CRT), a projector, a printer or other now known or later developed display device for outputting determined information. The display 314 may act as an interface for the user to see the functioning of the processor 302, or specifically as an interface with the software stored in the memory 304 or in the drive unit 306.

Additionally, the computer system 300 may include an input device 316 configured to allow a user to interact with any of the components of system 300. The input device 316 may be a number pad, a keyboard, or a cursor control device, such as a mouse, or a joystick, touch screen display, remote control or any other device operative to interact with the system 300.

In a particular embodiment, as depicted in FIG. 4, the computer system 300 may also include a disk or optical drive unit 306. The disk drive unit 306 may include a computer-readable medium 310 in which one or more sets of instructions 312, e.g. software, can be embedded. Further, the instructions 312 may embody one or more of the methods or logic as described herein. In a particular embodiment, the instructions 312 may reside completely, or at least partially, within the memory 304 and/or within the processor 302 during execution by the computer system 400. The memory 304 and the processor 302 also may include computer-readable media as discussed above.

The present disclosure contemplates a computer-readable medium that includes instructions 312 or receives and executes instructions 312 responsive to a propagated signal, so that a device connected to a network 320 can communicate voice, video, audio, images or any other data over the network 320. Further, the instructions 312 may be transmitted or received over the network 320 via a communication port 318. The communication port 318 may be a part of the processor 302 or may be a separate component. The communication port 318 may be created in software or may be a physical connection in hardware. The communication port 318 is configured to connect with a network 320, external media, the display 314, or any other components in system 300, or combinations thereof. The connection with the network 320 may be a physical connection, such as a wired Ethernet connection or may be established wirelessly as discussed below. Likewise, the additional connections with other components of the system 300 may be physical connections or may be established wirelessly.

The network 320 may include wired networks, wireless networks, or combinations thereof, and may be representative of the networks 206 and/or 208. The wireless network may be a cellular telephone network, an 802.11, 802.16, 802.20, or WiMax network. Further, the network 320 may be a public network, such as the Internet, a private network, such as an intranet, or combinations thereof, and may utilize a variety of networking protocols now available or later developed including, but not limited to TCP/IP based networking protocols.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is therefore intended that the foregoing detailed description be regarded as illustrative rather than limiting, and that it be understood that it is the following claims, including all equivalents, that are intended to define the spirit and scope of this invention.

We claim:

1. A computer implemented method for enhancing the facilitation of access to content by a plurality of content consumers, the content provided by a content provider, the method comprising:
receiving, by a computer associated with a content host, the content;
making the content available for access by the plurality of content consumers;
obtaining, by the computer, data related to access to the content by at least one of the plurality of content consumers;
analyzing, by the computer, the obtained data;
formulating, based on the analysis, by the computer, one or more recommendations corresponding to the content; and
providing the one or more recommendations to the content provider.

2. The computer implemented method of claim 1, wherein making the content available for access comprises sharing the content with the plurality of content consumers and notifying the plurality of content consumers that the content has been shared.

3. The computer implemented method of claim 1, wherein making the content available for access comprises providing the content to the plurality of content consumers via the computer, the content categorized into one or more rooms.

4. The computer implemented method of claim 1, wherein making the content available for access comprises providing the content to the plurality of content consumers based on one or more permissions provided by the content provider.

5. The computer implemented method of claim 1, wherein obtaining the data related to the access to the content comprises collecting data related to an extent, nature, or characteristic of the access to the content.

6. The computer implemented method of claim 1, wherein analyzing the obtained data comprises identifying one or more content access patterns for the at least one content consumer.

7. The computer implemented method of claim 1, wherein analyzing the obtained data comprises correlating the obtained data with transaction data indicative of previously consummated transactions.

8. The computer implemented method of claim 1, wherein formulating the one or more recommendations comprises formulating one or more recommended modifications to the content.

9. The computer implemented method of claim 1, wherein formulating the one or more recommendations comprises formulating one or more recommended actions to be performed by the content provider based on the content.

10. The computer implemented method of claim 1, further comprising automatically modifying, by the computer, the content based on the one or more recommendations.

11. A system for enhancing the facilitation of access to content by a plurality of content consumers, the content provided by a content provider, the system comprising:
a content platform associated with a content host and in communication with the content provider and the plurality of content consumers,
wherein the content platform is configured to receive the content and make the content available for access by the plurality of content consumers,
wherein the content platform is configured to determine when at least one of the plurality of content consumers has accessed the content, collect data related to access to the content by the at least one content consumer, and analyze the collected data, and
wherein the content platform is configured to generate one or more recommendations based on the analysis of the obtained data, the one or more recommendations corresponding to the content.

12. The system of claim 11, wherein the content comprises text.

13. The system of claim 11, wherein the content comprises one or more images.

14. The system of claim 11, wherein the content comprises video content.

15. The system of claim 11, wherein the content comprises audio content.

16. The system of claim 11, wherein the content platform comprises a user interface, and wherein the content platform is configured to make the content available for access by the plurality of content consumers via the user interface.

17. The system of claim 11, wherein the system further comprises a permission matrix provided by the content provider, and wherein the content platform is configured to make the content available for access by the plurality of content consumers based on the permission matrix.

18. The system of claim 11, wherein the collected data is related to an extent, nature, or characteristics of the access to the content by the at least one content consumer.

19. The system of claim 11, wherein the one or more recommendations comprise one or more recommended modifications to the content, one or more recommended actions to be performed based on the content, or a combination thereof.

20. The system of claim 19, wherein the one or more recommended modifications comprise one or more recommended edits, deletions, additions, or combinations thereof, to the content.

21. The system of claim 19, wherein the one or more recommended modifications comprise one or more recommendations to re-arrange portions of the content.

22. The system of claim 11, wherein the content platform is further configured to automatically modify the content based on the one or more generated recommendations.

23. A system for enhancing the facilitation of access to content by a plurality of content consumers, the content provided by a content provider, the system comprising a processor, a memory coupled with the processor, and a network interface operative to couple the processor with the content provider and the plurality of content consumers, the system further comprising:
first logic stored in the memory and executable by the processor to cause the processor to receive the content from the content provider;
second logic, coupled with the first logic, stored in the memory and executable by the processor to cause the processor to make the content available for access by the plurality of content consumers;
third logic, coupled with the second logic, stored in the memory and executable by the processor to cause the processor to obtain data related to access to the content by at least one of the plurality of content consumers;
fourth logic, coupled with the third logic, stored in the memory and executable by the processor to cause the processor to analyze the obtained data;
fifth logic, coupled with the fourth logic, stored in the memory and executable by the processor to cause the processor to formulate one or more recommendations corresponding to the content based on the analysis of the obtained data; and
sixth logic, coupled with the fifth logic, stored in the memory and executable by the processor to cause the processor to provide the one or more recommendations to the content provider.
